(19) United States
(12) Patent Application Publication
(10) Pub. No.: US 2022/0414401 A1
(43) Pub. Date: Dec. 29, 2022

(54) AUGMENTING TRAINING DATASETS FOR MACHINE LEARNING MODELS

(71) Applicant: International Business Machines Corporation, Armonk, NY (US)

(72) Inventors: Yannick Saillet, Stuttgart (DE); Chris Immanuel Harlander, Boeblingen (DE)

(21) Appl. No.: 17/356,053

(22) Filed: Jun. 23, 2021

(51) Int. Cl. G06K 9/62; G06N 20/00

(52) U.S. Cl. CPC G06K 9/6262; G06N 20/00

(57) ABSTRACT

A machine-learning model that is using production data and is operating in a production environment within a data-sensitive realm is analyzed, where this model was trained using a training dataset. An accuracy of the model is identified as falling below an accuracy threshold when providing one or more predictions of a subset of the production data. At least one characteristic of the production data that is used to predict the subset of the production data is determined to be underrepresented in the training dataset. The one or more predictions and the at least one characteristic are provided to a location outside of the production environment.

### BACKGROUND

Before being deployed into a customer-facing setting, machine-learning (ML) models are typically trained to verify that the models are properly configured (e.g., will return accurate predictions for respective records). The quality of a model (e.g., how well that model is trained/configured) is often directly relational to the quality of the data with which the model is trained. This data is typically referred to as “training data.” The training data has more or less quality when that training data is more or less representative of the real or “production” data that the model will be analyzing when eventually deployed into that customer-facing setting. As such, any deficiency in the training data will often cause one or more corresponding deficiencies in the model upon deployment as a result of the model not being trained to handle some aspects of the production data.

### SUMMARY

Aspects of the present disclosure relate to a method, system, and computer program product relating to improving the quality of training dataset for training a machine learning model. For example, the method includes analyzing a machine-learning model that is using production data and is operating in a production environment within a data-sensitive realm, where this model was trained using a training dataset. The method also includes identifying an accuracy of the model falling below an accuracy threshold when providing one or more predictions of a subset of the production data. The method also includes determining at least one characteristic of the production data used to predict the subset of the production data that is underrepresented in the training dataset. The method also includes providing the one or more predictions and the at least one characteristic outside of the production environment. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which a controller may improve training data for a machine learning model.

FIG. 2 depicts a conceptual box diagram of example components of the controller of FIG. 1.

FIG. 3 depicts an example flowchart by which the controller of FIG. 1 may improve the training data for a machine learning model.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to improving the quality of training data for machine learning, while more particular aspects of the present disclosure relate to identifying that a machine learning (ML) model in a data-sensitive realm is receiving records that have characteristics that are suboptimally represented in training data that was used to train that ML model, in response to which those characteristics are extracted and provided along with the prediction data in order to update the training dataset and retrain the ML model. While the present disclosure is not necessarily limited to such applications, various aspects of the disclosure may be appreciated through a discussion of various examples using this context.

A quality and general accuracy of a respective machine learning (ML) model is typically at least partially dependent on the quality of the training data (hereinafter typically referred to as the “training dataset”) that was used to train the model. Once a model is fully trained it is typically placed in a customer-facing environment where it analyzes/processes data from/of/for the customer. This customer-facing environment is referred to herein as a production environment, and the data that the model receives/analyzes/predicts when within this production environment is referred to as production data. If a model is trained with training data that does not include some aspects of the eventual production data, and/or if the training dataset includes/does not include associations between characteristics that are/aren't reflected in the production data, the model may incorrectly/suboptimally respond to the production data when put in the production environment. Accordingly, in conventional applications, a great amount of time and consideration is used to generate the training dataset to ensure that the training dataset is representative of and accurate to the production data that the model will see in production.

Specifically, in a conventional training situation, a set of training data is curated such that this training dataset is already mapped to known “accurate” results as should be provided by the model (these results are referred to herein as “predictions”), such that the model “predicts” some of training dataset into, e.g., one or more of a set of predetermined classes. In this way, a skilled data scientist may feed in training data and inform the model if the model is returning accurate predictions (in which case the model reinforces steps and logic that lead to this prediction), inaccurate predictions (in which case the model de-emphasizes steps and logic that lead to this prediction), and/or incomplete predictions (in which case the model reinforces some logic and de-emphasizes other logic). The training dataset may be divided into one training set (from which the model may learn its logic) and a test set (with which an accuracy of the model may be tested). This process may often require numerous iterations, where a model will be trained for a portion of time, and then tested for the analyst to test progress, and then feed more training data based on the test (e.g., where the model is feed training data that corresponds to predictions for which the model failed an accuracy threshold). While this disclosure primarily relates to the training data, these iterations also often includes changing various model parameters relating that are configurable by the data scientist training the model. In this way, a trained operator may validate a model as being fully trained at accurately predicting the training data, at which point can be deployed to the production environment.

In some situations, a model may be used in a production environment in which some or all of the data used and/or captured is “sensitive,” where sensitive data includes data for which access is controlled/restricted (e.g., whether as a result of regulation, protocol, respect, or the like). Production data may be in a data sensitive realm when there is some concern over who might see and/or analyze specific data points of the production data. Conversely, production data may be in a realm that is not particularly sensitive when some, most, or all of the production data may be forwarded or otherwise accessed in whole or in part by a third party to the production environment without concern for breeching some confidentiality for that data.

For example, a model may be used in international customs to predict information such as categorical information on an animal going through customs, and it may be determined that the model is doing a poor job at accurately predicting/classifying some animals as being one species or another (e.g., classifying a Bengal house cat as a leopard), or as having one condition or another (e.g., classifying a healthy animal as an unhealthy animal that is exhibiting signs of a transmittable medical condition). It may be determined that this production data (e.g., the images of one or more Bengal house cats that were inaccurately predicted as leopards) is not sensitive, such that this data may be forwarded to a data scientist with minimal/no privacy concerns. In such a conventional setting when working in a production environment that does not include sensitive data, the data scientist may use this actual production data that resulted in inaccurate predictions to quickly and confidently retrain the model by analyzing how the specific configuration of production data caused the specific inaccurate predictions.

However, in many conventional settings, models are deployed into a production environment in a data-sensitive realm such that it may be extremely difficult and/or impossible for a data scientist to get the production data that resulted in inaccurate predictions. For example, the production data may include medical data, personal identifying data (e.g., a social security number), financial data, or other types of data which one or more users or entities do not wish to share and/or are not permitted to share. In such conventional applications, data scientists may be forced to make educated guesses as to the manner in which their previously-applied training dataset was insufficient in reflecting the production data (and/or was insufficient in reflecting changes over time that occurred in the production data).

For example, a conventional data scientist may attempt to make educated guesses as to how the training dataset needs to be updated by relying on high-level summaries of how the model failed (e.g., “the model failed as it predicted [thing A] as [thing B]”). However, without the accompanying production data that caused such misprediction, it may be difficult and time-consuming for a data scientist to identify what specific and/or interrelated characteristics of the production data causes the model to return such a misprediction (e.g., as during training the model may have “passed” a test at accurately predicting [thing A] as [thing A] via the training dataset that, unbeknownst to the data scientist, did not comprehensively reflect the production environment and the production data that the model would be seeing). Further, even once the data scientist identifies what set of characteristics may cause a misprediction, it may be difficult and time-intensive (and may cause numerous iterations between deployment and retraining) before the data scientist generates a training dataset of sufficient size that accurately reflets the natural vagaries of the production data, such that retraining the model with this new training dataset will truly correct this deficiency.

In some conventional systems, systems may attempt to solve accuracy problems of ML models caused by gaps between training datasets and production data by identifying datapoints of training datasets that are not reflected in the production data. For example, a system may have access to the training dataset that was used to train a model, and may highlight and/or identify one or more portions of the training dataset that are not found in the production data. Such a conventional system may then provide these identified “extra” portions of the training dataset without sharing any sensitive data, being as nothing from the production data was shared. Thus, if a data scientist is told that a model is failing to predict thing A, the data scientist may identify whether or not any of the “extra” datapoints of the training dataset that were not reflected in the production data may have caused this misprediction. However, as would be understood by one of ordinary skill in the art, though extra non-reflective datapoints of the training dataset can cause mispredictions, it is just as common (if not more common) that it is a dearth of accurate datapoints in the training dataset (rather than an abundance of unrepresentative datapoints) that causes mispredictions. As such, while conventional efforts to highlight datapoints within a training dataset that can be deleted may be helpful, they very frequently fail to fully solve the problem.

Aspects of this disclosure may solve or otherwise address some or all of these problems of conventional systems by identifying characteristics of the production data (and interrelations thereof) that are suboptimally represented in training datasets. A computing device that includes a processing unit executing instructions stored on a memory may provide the functionality that can identify and provide characteristics of the production data that are underrepresented in the training dataset (and are subsequently causing mispredictions) and therein solve the problems of conventional solutions, this computing device herein referred to as a controller. This controller may be provided by a standalone computing device as predominantly described below for purposes of clarity, though in other examples the controller may be integrated into the production environment and/or a model management platform that is privy to the production data.

For example, the controller may collect information about the records on which the model is not performing well while the model is deployed in the production environment. This may include collecting information at a regular interval, collecting information when the classifications/predictions of the model can be verified, and/or capturing records which resulted in an incorrect prediction. In some examples, the controller may gather data as it comes to a model, whereas in other examples the controller may gather data as a validation step after prediction.

Once the controller has the production data collected, the controller may determine (e.g., using various data mining/analysis techniques described herein) statistically significant characteristics of these records that were not predicted with at least a threshold amount of accuracy. The controller may further compare data of these records against data of the training dataset that was used to train the model to identify one or more of these statistically significant characteristics (and interrelations thereof) that was inaccurately represented in the training dataset. These identified characteristics (and the associated mispredictions) may be returned by the controller to the data scientist. In some examples, the controller may further provide some bounds of these characteristics, such as a general likelihood of the characteristics, varying values of these characteristics, or the like. By providing characteristics of production data that seemingly were mispredicted by the model and were suboptimally represented by the training data without providing any of the actual production data, aspects of this disclosure may improve an ability to train models with a high degree of accuracy by improving an ability for training data to accurately reflect production data in data-sensitive realms.

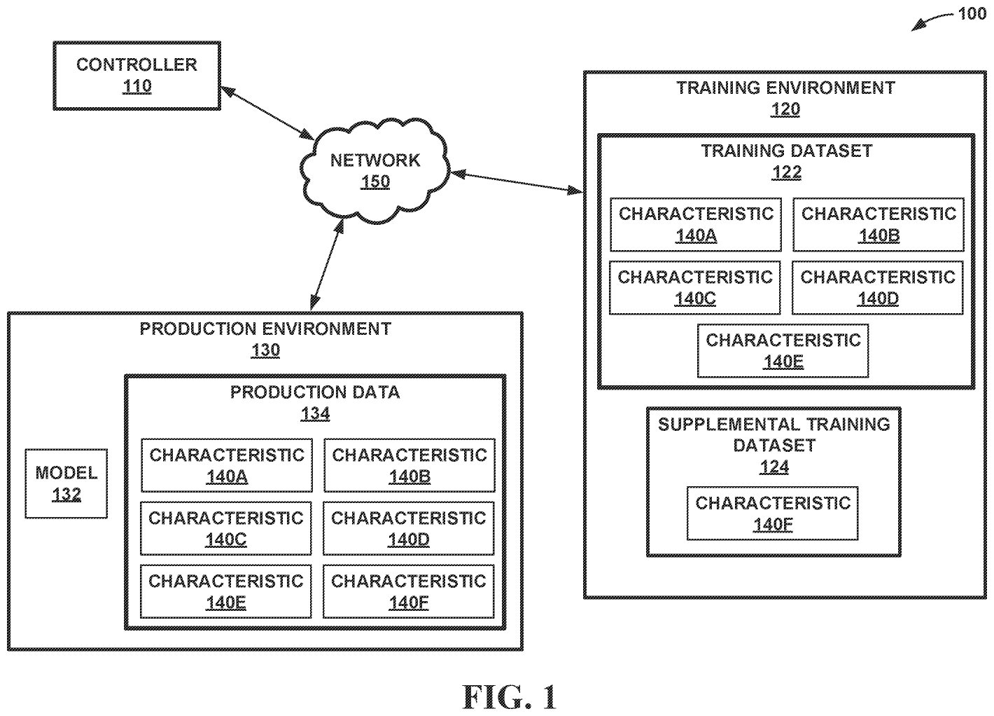

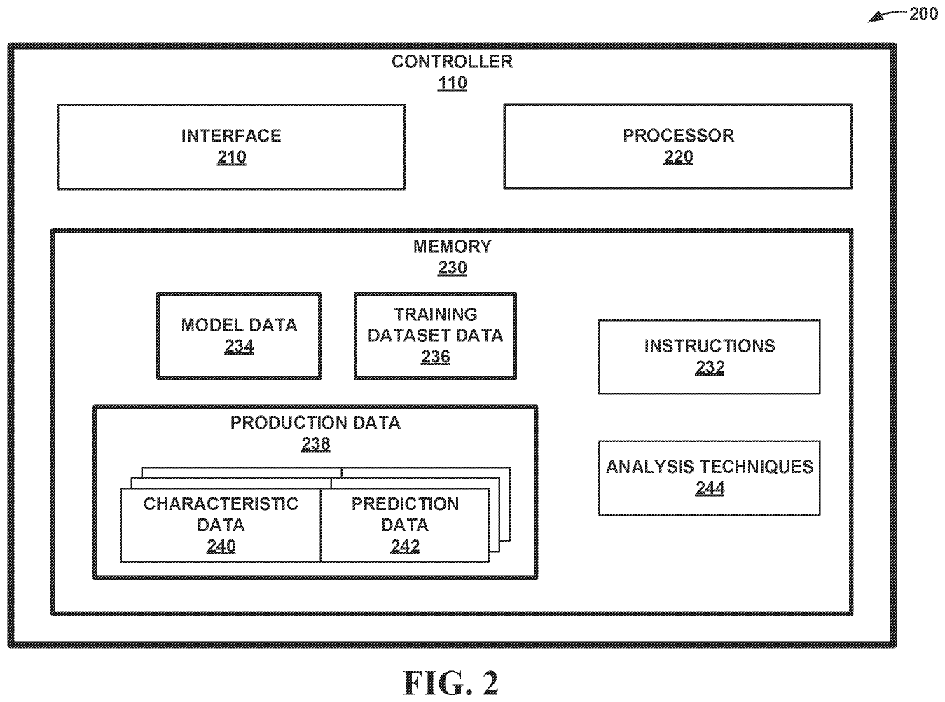

For example, FIG. 1 depicts environment 100 in which controller 110 identifies one or more characteristics 140A-140F (collectively referred to herein as “characteristics 140”) of records of production data 134 within production environment 130 that are suboptimally represented in training dataset 122 of training environment 120. Controller 110 may include a computing device, such as computing system 200 of FIG. 2 that includes a processor communicatively coupled to a memory that includes instructions that, when executed by the processor, causes controller 110 to execute one or more operations described below. In some examples, production environment 130 is hosted on one or more computing devices that comprise controller 110, though in other examples production environment 130 may be hosted/provided by separate computing devices (e.g., that are each similar to computing system of FIG. 2). In other examples (not depicted), the functionality ascribed to controller 110 may be provided by one or more management platforms of production environment 130 that have full access to all production data 134 of production environment 130.

Model 132 may be trained in training environment 120 with training dataset 122. Training dataset 122 may have been created to approximate production data 134. In some examples, a data scientist may generate training dataset 122 from a corpus of data that the data scientist identifies as being relevant to production environment 130. As discussed herein, production data 134 may be in a data-sensitive realm, such that the actual production data 134 may be inaccessible to the data scientist. Therefore, the data scientist may generate training dataset 122 and therein train model 132 without ever accessing production data 134 and/or production environment 130.

Controller 110 may detect when model 132 is deployed in production environment 130. Controller 110 may begin monitoring a performance of model 132 responsive to this deployment. For example, controller 110 may analyze an accuracy with which model 132 predicts records of production data 134 of production environment 130. As used herein, a record of production data 134 may include a self-contained set of production data 134 that was received and/or organized for purposes of being predicted (e.g., predicted by model 132). For example, model 132 may be trained to predict medical images as indicating a presence or lack of a medical condition, where each record is a medical image (or a set of medical images of a single patient).

Controller 110 may monitor a performance of model 132 by tracking a rate at which model 132 accurately predicts records within production environment 130. For example, controller 110 may identify whether or not model 132 is able to predict records with a threshold amount of accuracy (e.g., correctly identifying at least 95% of elements of a record such that the record is predicted as belonging to one of a set of predetermined classes at least 95% of the time). In some examples, an accuracy threshold may be 100%, such that a single inaccurate prediction as identified by controller 110 may cause controller 110 to identify model 132 as falling below the accuracy threshold. Controller 110 may determine an accuracy by any mechanism known to one of ordinary skill in the art. In some examples, controller 110 may identify that a record was inaccurately predicted by model 132 via a notification from a human user (e.g., a medical doctor that received the prediction of a medical image from model 132 and provides a notifications that the prediction is incorrect). In other examples, controller 110 may have access to another system that determines an “actual” value of the predicted/classified value at a future point in time, such that the accuracy is determined by how well the initial prediction result from model 132 matches with this actual detected future result (e.g., for example where model 132 forecasts whether, such that an “actual” weather is determined following the prediction).

Controller 110 may compare production data 134 to training dataset 122. For example, controller 110 may compare characteristics 140 identified within production data 134 to characteristics 140 of training dataset 122. For example, controller 110 may analyze whether or not there are some characteristics 140 of production data 134 that are not in training dataset 122, or are not present in the same relative volume, or vice versa (e.g., whether some characteristics 140 of training dataset 122 are not present in production data 134 at all, or in the same relative volume as they exist within training dataset 122).

Controller 110 may compare characteristics 140 of production data 134 to characteristics 140 of training dataset 122 to determine whether general ratios and patterns of characteristics 140 match general ratios and patterns of characteristics 140 in training dataset 122. For example, controller 110 may detect that training dataset 122 is organized into various predictions, where, e.g., a first portion of training dataset 122 is for prediction ABC, while a second portion of training dataset 122 is for prediction DEF, etc. Controller 110 then check whether records that model 132 predicts as prediction ABC have production environment 130 characteristics 140 that correspond with characteristics 140 of the portion of training dataset 122 that correspond to prediction ABC.

In some examples, controller 110 may detect a situation where one or more specific combinations of characteristics 140 that are organized as associated with a given prediction within training dataset 122 seem to be different than the combinations of characteristics 140 that are associated with that same prediction in production data 134. For example, controller 110 may analyze all characteristics 140 of training dataset 122 and production data 134 and determine that a portion of training dataset 122 that corresponds to a prediction ABC includes either characteristics 140A, 140B, 140C or characteristics 140C, 140D, 140E, while records of production data 134 that correspond to the same prediction ABC includes characteristics 140C, 140D, 140E, 140F (e.g., such that training dataset 122 does not include characteristic 140F for prediction ABC). Controller 110 may detect that this characteristic 140F has a statistically significant correlation to the prediction ABC within production data 134, and may therein provide this new characteristic 140F (and the corresponding prediction ABC) to a location external to production environment 130 so that model 132 can be retrained using this new characteristic 140F.

For example, controller 110 may provide characteristic 140F so that supplemental training dataset 124 may be created with characteristic 140F. Model 132 may be retrained with supplemental training dataset 124 that includes this newly identified characteristic 140F (e.g., in addition to other characteristics 140A-140E). In some examples, controller 110 may provide characteristic 140F in such a manner that a trained data scientist could generate supplemental training dataset 124 (and therein retrain model 132) in a manner that is representative of characteristic 140F within production data 134. In other examples, controller 110 may be configured to autonomously (e.g., without human supervision or control) generate supplemental training dataset 124 itself. For example, controller 110 may be configured to autonomously generate supplemental training dataset 124 by generating an initial set of data that is entirely new (e.g., is not copied from production data 134) and is representative of production data 134, such that, e.g., a data scientist may review this supplemental training dataset 124 prior to retraining model 132 with it. Controller 110 may generate supplemental training dataset 124 such that it has a threshold number of records that each include characteristic 140F, to ensure that the supplemental training dataset 124 is large and robust enough to fully train model 132 regarding characteristic 140F. For example, if model 132 is an image classifier or an optical character recognition (OCR) system where text is recited as a picture and predicted and transformed in structured text, suppose model 132 was trained on training dataset 122 that include a large set of texts using different fonts and text and background colors, but once deployed into production environment 130 some production data 134 includes texts with a specific combination of text/background color and/or font type that model 132 does not properly recognize and then predict. Controller 110 may detect this misprediction and subsequently generated supplemental training dataset 124 by transforming existing training dataset 122 and changing respective color or font of training dataset 122 to include these specific combinations of text color, background color, and/or font type. In certain examples, controller 110 may even be configured to autonomously retrain model 132 with this supplemental training dataset 124.

Controller 110 may provide this characteristic 140F in a manner such that no sensitive data is provided (e.g., no specific production data 134 is provided). For example, controller 110 may provide characteristic 140F such that numerous individual records may be generated within supplemental training dataset 124 that include characteristic 140F, without providing any single record of production data 134 that reflects characteristic 140F. In some examples, in addition to providing the identified characteristic 140, controller 110 may provide one or more statistical relationships between the identified characteristic 140F and other characteristics 140. For example, controller 110 may identify that characteristic 140F is typically identified with some combination of characteristics 140C, 140D, and 140E as provided above, and/or that characteristic 140F is never in a record with characteristic 140A.

In some examples, controller 110 may provide statistically significant characteristic 140F to training environment 120 for training upon detecting that characteristic 140F is not in training dataset 122 in a manner analogous to how characteristic 140F is present within production data 134 (e.g., whether being underrepresented in training dataset 122, inaccurately overrepresented, overrepresented, or the like). In other examples, controller 110 may primarily and/or exclusively provide characteristic 140F to training environment 120 in response to detecting that model 132 is predicting records with less than a threshold accuracy. For example, controller 110 may provide characteristic 140F to training environment in response to detecting that records that contain characteristic 140F are accurately predicted with less than a threshold accuracy.

Controller 110 may access production environment 130 and/or training environment 120 over network 150. Network 150 may include a computing network over which computing messages may be sent and/or received. For example, network 150 may include the Internet, a local area network (LAN), a wide area network (WAN), a wireless network such as a wireless LAN (WLAN), or the like. Network 150 may comprise copper transmission cables, optical transmission fibers, wireless transmission, routers, firewalls, switches, gateway computers and/or edge servers. A network adapter card or network interface in each computing/processing device (e.g., controller 110 and/or computing devices that host training environment 120 and/or production environment 130) may receive messages and/or instructions from and/or through network 150 and forward the messages and/or instructions for storage or execution or the like to a respective memory or processor of the respective computing/processing device. Though network 150 is depicted as a single entity in FIG. 1 for purposes of illustration, in other examples network 150 may include a plurality of private and/or public networks.

As described above, controller 110 may include or be part of a computing device that includes a processor configured to execute instructions stored on a memory to execute the techniques described herein. For example, FIG. 2 is a conceptual box diagram of such computing system 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with computing devices that host training environment 120, production environment 130, or the like. Interface 210 may include one or more network interface cards, such as Ethernet cards and/or any other types of interface devices that can send and receive information. Any suitable number of interfaces may be used to perform the described functions according to particular needs.

As discussed herein, controller 110 may be configured to identify characteristics 140 of production data 134 that are inaccurately represented in training dataset 122. Controller 110 may utilize processor 220 to thusly identify suboptimally represented and statistically significant characteristics in order to improve model training. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to identify how to improve model training datasets.

Processor 220 may identify characteristics that can improve model training datasets according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may identify negative rules as described herein according to instructions 232 of one or more applications (e.g., software applications) stored in memory 230 of controller 110.

In addition to instructions 232, in some examples gathered or predetermined data or techniques or the like as used by processor 220 to identify characteristics 140 to be added to/altered within training dataset 122 as described herein may be stored within memory 230. For example, memory 230 may include information described above from production environment 130 (e.g., in situations where controller 110 is integrated into and/or functionality of production environment 130), such as data from model 132, production data 134, and/or characteristics 140. For example, as depicted in FIG. 2, memory 230 includes model data 234, production data 238 (which itself includes characteristic data 240), and prediction data 242. Model data 234 may include model 132 itself, and/or rules or metadata of model 132. In some examples, model data 234 may include accuracy thresholds that model 132 is to be held to, which may be the same for all predictions or unique to each/some predictions.

As depicted, production data 238 may be stored in memory 230 such that characteristic data 240 is correlated with prediction data 242. For example, prediction data 242 may include a name of a predetermined class, and characteristic data 240 may include the sets of characteristics 140 that model 132 has predicted as belonging to that class. Characteristic data 240 may include each given set of characteristics 140 that is determined by model 132 to be associated with a single prediction.

Memory 230 may also include training dataset data 236, which may include some or all of training dataset 122. For example, where controller 110 is integrated into production environment 130, controller 110 may download some or all of training dataset 122 into training dataset data 236 so that controller 110 may compare characteristic data 240 of production environment 130 against characteristics 140 is stored in training dataset data 236 as described herein.

Memory 230 may further include analysis techniques 244. Analysis techniques 244 may include techniques used by controller 110 to identify characteristics 140 that have statistically significant relationships to other characteristics 140 and/or predictions that are suboptimally represented in training dataset 122. For example, analysis techniques 244 may include a clustering technique, an associations algorithm, a tree classification, a neural network, a set of statistical distributions, a set of bivariate statistics, a combination of these, or any other such analysis known by one of ordinary skill in the art. For example, the clustering technique may include controller 110 extracting the records that lead to/resulted in model 132 providing an incorrect prediction/classification, upon which controller 110 could execute a clustering algorithm to identify statistically significant characteristics 140. Controller 110 could compare these statistically significant characteristics 140 to characteristics 140 within training dataset 122 and identify whether to add such a candidate characteristic 140 to training dataset 122 by measuring the “distance” of these candidate characteristics 140 to one of the clusters identified for the failing records.

For another example, the association algorithm (e.g., an apriori algorithm) may include controller 110 building a list of “transactions” made up of characteristics 140 of the records within production data 134, where controller 110 subsequently creates a label indicating if model 132 classified the record correctly (e.g., where a transaction for a record of characteristics 140 includes {gender=F, age=28-35, salary=3000-5000, prediction=incorrect}, where each of gender/age/salary are characteristics 140). Controller 110 may then create a “model” of all of the association rules by running an association rules algorithm on all of the transactions while using a filter to keep rules where the prediction is identified as incorrect (e.g., where the transaction included “prediction=incorrect”). This associations rules model may be created to contain a full set of the rules (e.g., as identified by the combinations of column values) that have been identified as resulting in inaccurate predictions. Controller 110 may then determine whether or not to add/change characteristics 140 within training dataset 122 by applying this association model on each record candidate that includes the identified characteristic 140 to determine if it matches one of the rules.

For another example, controller 110 may use a classification model or the like (e.g., a tree classification model) to build a classification model to predict the likelihood that a given record is going to lead to a false prediction. When searching for new candidates records to be provided within supplemental training dataset 124 that include statistically significant yet suboptimally represented characteristic 140F, controller 110 may apply such a classification model on each candidate record to verify whether or not it matches the identified deficiency of the original training dataset 122.

Beyond these techniques, analysis techniques 244 may also include many other machine learning techniques that controller 110 may use to improve a process of identifying characteristics 140 that are suboptimally provided by training dataset 122 as discussed herein over time. Machine learning techniques can comprise algorithms or models that are generated by performing supervised, unsupervised, or semi-supervised training on a dataset, and subsequently applying the generated algorithm or model to identify characteristics 140 to be added to (or otherwise changed within) training dataset 122.

Machine learning techniques can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. For example, machine learning techniques can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

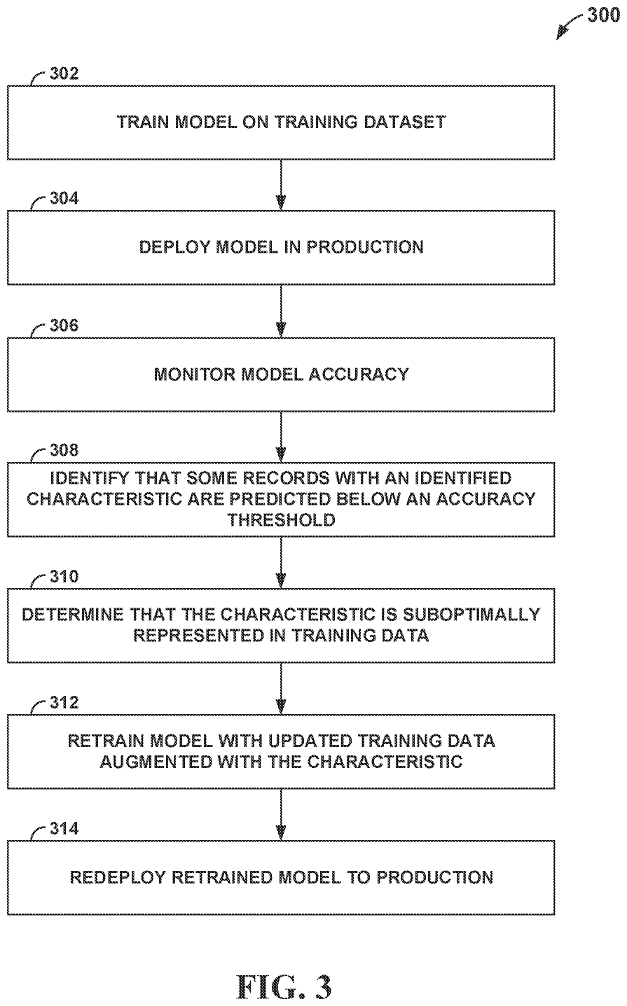

Using these components, controller 110 may identify characteristics 140 of production environment 130 that are suboptimally represented in training dataset 122 as discussed herein. For example, controller 110 may identify characteristics according to flowchart 300 depicted in FIG. 3. Flowchart 300 of FIG. 3 is discussed with relation to FIG. 1 for purposes of illustration, though it is to be understood that other systems may be used to execute flowchart 300 of FIG. 3 in other examples. Further, in some examples controller 110 may execute a different method than flowchart 300 of FIG. 3, or controller 110 may execute a similar method with more or less steps in a different order, or the like.

Flowchart 300 begins with model 132 being trained in training environment 120 with training dataset 122 (302). In some examples one or more data scientists may create training dataset 122 without access to any production data 134, and these data scientists (and/or other ML operators) may subsequently train model 132 with this developed training dataset 122. In other examples, controller 110 may (without access to production data 134) assist in either generating training dataset 122 and/or training model 132.

Model 132 is deployed into production environment 130 (304). Controller 110 may deploy model 132 into production environment 130. Controller 110 may deploy model 132 to production environment 130 from training environment 120.

Controller 110 monitors an accuracy of model 132 within production environment 130 (306). Controller 110 may monitor whether or not model 132 analyzes production data 134 with a threshold amount of accuracy. In some examples, controller 110 may use a single threshold of accuracy for all predictions that model 132 provides, whereas in other examples controller 110 may have a relatively higher or lower threshold for different predictions (e.g., such that controller 110 determines that model 132 has satisfied a threshold accuracy for a first prediction if it is accurately predicted at least 98% of the time, whereas another prediction model 132 has a threshold of 100%, such that a single false prediction results in a failure of this second prediction accuracy threshold).

Controller 110 identifies that some records are predicted below an accuracy threshold, and further identifies that these records have one or more identified characteristics 140 (308). For example, this characteristic 140 may include a graphical feature if the record is an image, or a demographic feature if the record is a patient, or a financial factor is the record is a financial asset, or the like. In response to this determination, controller 110 compares each of these one or more identified characteristics that are associated with this inaccurate prediction to characteristics 140 within training dataset 122. Controller 110 determines that at least one of these characteristics 140 is suboptimally represented in training dataset 122 (310). For example, controller 110 may determines that this characteristic 140 is underrepresented, overrepresented, or otherwise inaccurately represented in training dataset 122.

In response to this determination, controller 110 provides this suboptimally characteristic 140 and the associated inaccurate prediction to a location external to production environment 130. For example, controller 110 may provide this characteristic 140 and the prediction to training environment 120. For another example, controller 110 may provide this characteristic 140 and the prediction directly to one or more data scientists (e.g., via an e-mail or other form of notification). Controller 110 may provide this characteristic and the prediction in such a manner such that none of production data 134 is provided.

In some examples, once controller 110 determines that model 132 has less than a threshold amount of accuracy, controller 110 may remove model 132 from production environment 130 (or otherwise stop model 132 from providing “live” predictions of production data 134). In other examples, controller 110 may have a first version of model 132 continue providing predictions of production data 134 while a copy of model 132 is being retrained with supplemental training dataset 124 (312), where this copy of model 132 will replace the production version of model 132 upon the completion of retraining. Where controller 110 keeps model 132 in production environment 130 upon detecting that model 132 is failing an accuracy threshold, controller 110 may take a remedial action to avoid inaccurate predictions causing problems of production data 134. For example, controller 110 may cause any prediction from model 132 to be provided along with a disclaimer of the identified accuracy issue, and/or controller 110 may only provide a disclaimer when model 132 is identified as providing a prediction for which model 132 has previously been identified as providing inaccurate predictions. In some examples, controller 110 may block model 132 from providing one or more predictions in response to determining that model 132 has less than a threshold amount of accuracy in providing those one or more predictions. Specifically, controller 110 may cause production environment 130 to return a disclaimer (e.g., a note with feedback indicating information regarding the potential reduced quality of the prediction) rather than have model 132 provide any prediction in response to a record having the suboptimally represented characteristic 140.

For example, while a new version of model 132 is being retrained (with supplemental training dataset 124), the current version of model 132 may still continue to work as usual in production environment 130 for records whose characteristics 140 are detected to work well with the current version of model 132, and block the prediction for records which are expected not to work with at least the threshold amount of accuracy with the current version of model 132 (or give a disclaimer as mentioned above, but only for records with the problematic characteristics 140). From a process point of view, this would result in controller 110 identifying characteristics 140 when a record comes in to determine whether or not the current version of model 132 is expected to predict with at least the threshold amount of accuracy. If controller 110 determines that the current version of model 132 is expected to predict with at least the threshold amount of accuracy, then controller 110 enables the current version of model 132 to predict this record without restriction. If controller 110 determines that the current version of model 132 is not expect to predict with at least the threshold amount of accuracy, then controller 110 may return the disclaimer, and/or route the record to a queue to be processed later by a human or once the new retrained version of model 132 is ready. By configuring controller 110 to thusly react to a subset of incoming records that controller 110 has detected that the current version of model 132 predicts with less than the threshold accuracy, controller 110 may improve an accuracy of and confidence in model 132.

Model 132 is retrained with an updated supplemental training dataset 124 that is augmented with this identified characteristic 140 (312). For example, if controller 110 determines that the identified characteristic 140 was underrepresented in training dataset 122, controller 110 augments supplemental training dataset 124 with increased characteristic 140, whereas if controller 110 determines that the identified characteristic 140 was overrepresented in training dataset 122, controller 110 may augment supplemental training dataset 124 by including relatively less of the identified characteristic 140. In some examples, a data scientist may develop the supplemental training dataset 124 via the identified characteristic 140 provided by controller 110, though in other examples controller 110 may assist in generating (or independently generate a first or final draft of) supplemental training dataset 124. Once retrained, model 132 is redeployed to production environment 130 (314). Controller 110 may redeploy model 132 to production environment 130.

For instance a model trained for calculating a credit risk may produce incorrect decision on certain demographic groups if these groups were not well represented in the training data used to build the model (ex: model was built using data where women between 18 and 35 with an income >60K$ in year are under-represented and may come with an incorrect prediction for a person belonging to that group).

Another problem is that even if the training data are representative for the production data at the time the model is put in production, the production data may evolve over the time so that after the while the model may become biased and needs to be retrained on updated representative data.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
analyzing a machine-learning model that is using production data operating in a production environment within a data-sensitive realm, wherein the model was trained using a training dataset;
identifying an accuracy of the model falling below an accuracy threshold when providing one or more predictions of a subset of the production data;
determining at least one characteristic of the production data used to predict the subset of the production data that is underrepresented in the training dataset; and
providing the one or more predictions and the at least one characteristic outside of the production environment.

2. The computer-implemented method of claim 1, further comprising:
generating a supplemental set of training data of at least a threshold number of records that each include the characteristic;
supplementing the training dataset with the supplemental set of training data; and
retraining the model with the supplemented training dataset.

3. The computer-implemented method of claim 2, further comprising:
identifying that the retrained model has an accuracy that satisfies the accuracy threshold; and
redeploying the retrained model into the production environment to use production data in the data-sensitive realm.

4. The computer-implemented method of claim 1, wherein the determining the at least one characteristic of the production data includes:
analyzing characteristics of the subset of production data; and
identifying that the at least one characteristic of the characteristics is statistically significant among the subset of production data in relation to the one or more predictions.

5. The computer-implemented method of claim 4, wherein the analyzing characteristics includes using at least one of a clustering algorithm, an associations algorithm, a classification model, a regression model, a statistical distribution, or bivariate statistics.

6. The computer-implemented method of claim 1, further comprising removing the model from the production environment in response to identifying the accuracy of the model falling below the accuracy threshold.

7. The computer-implemented method of claim 1, further comprising:
identifying a record being sent to the model for prediction, wherein the record has the at least one characteristic; and
returning a disclaimer rather than a prediction from the model in response to identifying the accuracy of the model falling below the accuracy threshold.

8. The computer-implemented method of claim 1, wherein the one or more predictions and the at least one characteristic are provided without providing any of the production data.

9. A system comprising:
a processor; and
a memory in communication with the processor, the memory containing instructions that, when executed by the processor, cause the processor to:
analyze a machine-learning model that is using production data operating in a production environment within a data-sensitive realm, wherein the model was trained using a training dataset;
identify an accuracy of the model falling below an accuracy threshold when providing one or more predictions of a subset of the production data;
determine at least one characteristic of the production data used to predict the subset of the production data that is underrepresented in the training dataset; and
provide the one or more predictions and the at least one characteristic outside of the production environment.

10. The system of claim 9, the memory containing additional instructions that, when executed by the processor, cause the processor to:
generate a supplemental set of training data of at least a threshold number of records that each include the characteristic;
supplement the training dataset with the supplemental set of training data; and
retrain the model with the supplemented training dataset.

11. The system of claim 9, the memory containing additional instructions that, when executed by the processor, cause the processor to:
identify that the retrained model has an accuracy that satisfies the accuracy threshold; and
redeploy the retrained model in the production environment to use production data in the data-sensitive realm.

12. The system of claim 9, wherein the determining the at least one characteristic of the production data includes:
analyzing characteristics of the subset of production data; and
identifying that the at least one characteristic of the characteristics is significant among the subset of production data.

13. The system of claim 9, the memory containing additional instructions that, when executed by the processor, cause the processor to:
identify a record being sent to the model for prediction, wherein the record has the at least one characteristic; and
return a disclaimer rather than a prediction from the model in response to identifying the accuracy of the model falling below the accuracy threshold.

14. The system of claim 9, the memory containing additional instructions that, when executed by the processor, cause the processor to remove the model from the production environment in response to identifying the accuracy of the model falling below the accuracy threshold.

15. A computer program product, the computer program product comprising a computer readable storage medium having program instructions embodied therewith, the program instructions executable by a computer to cause the computer to:
analyze a machine-learning model that is using production data operating in a production environment within a data-sensitive realm, wherein the model was trained using a training dataset;
identify an accuracy of the model falling below an accuracy threshold when providing one or more predictions of a subset of the production data;
determine at least one characteristic of the production data used to predict the subset of the production data that is underrepresented in the training dataset; and
provide the one or more predictions and the at least one characteristic outside of the production environment.

16. The computer program product of claim 15, the computer readable storage medium having additional program instructions embodied therewith that are executable by the computer to cause the computer to:
generate a supplemental set of training data of at least a threshold number of records that each include the characteristic;
supplement the training dataset with the supplemental set of training data; and
retrain the model with the supplemented training dataset.

17. The computer program product of claim 15, the computer readable storage medium having additional program instructions embodied therewith that are executable by the computer to cause the computer to:
identify that the retrained model has an accuracy that satisfies the accuracy threshold; and
redeploy the retrained model in the production environment to use production data in the data-sensitive realm.

18. The computer program product of claim 15, wherein the determining the at least one characteristic of the production data includes:
analyzing characteristics of the subset of production data; and
identifying that the at least one characteristic of the characteristics is significant among the subset of production data.

19. The computer program product of claim 15, the computer readable storage medium having additional program instructions embodied therewith that are executable by the computer to cause the computer to remove the model from the production environment in response to identifying the accuracy of the model falling below the accuracy threshold.

20. The computer program product of claim 15, the computer readable storage medium having additional program instructions embodied therewith that are executable by the computer to cause the computer to:
identify a record being sent to the model for prediction, wherein the record has the at least one characteristic; and
return a disclaimer rather than a prediction from the model in response to identifying the accuracy of the model falling below the accuracy threshold.
